(19) United States
(12) Patent Application Publication
(10) Pub. No.: US 2010/0081336 A1
(43) Pub. Date: Apr. 1, 2010

(54) CONNECTOR CONNECTION TERMINAL AND CONNECTOR USING THE SAME

(75) Inventors: Yoshinobu Hemmi, Otsu-shi (JP); Hirotada Teranishi, Kusatsu-shi (JP); Tadayuki Sakase, Ritto-shi (JP); Jiro Koyama, Otsu-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/572,133

(22) Filed: Oct. 1, 2009

(30) Foreign Application Priority Data
Oct. 1, 2008 (JP) 2008-256693

(51) Int. Cl. H01R 9/03

(52) U.S. Cl. 439/658

(57) ABSTRACT

A connector connection terminal has a fixed piece to be inserted and fixed to a base of a connector, a coupling portion projecting out from an upper side of the fixed piece, and a movable piece extending along the fixed piece from an upper end of the coupling portion and having one end as an upper contact and another end acting as an operation receiving portion. A lower contact is arranged at a position facing the upper contact of the upper side of the fixed piece. The operation receiving portion of the movable piece is operated with an operation lever rotatably supported by the base. An elastic arm is cut out with a slit formed along the upper side of the fixed piece to define a free end of the elastic arm as a lower contact. An aspect ratio of a cross-sectional area of the elastic arm is greater than or equal to 1.2.

### BACKGROUND OF INVENTION

1. Technical Field

The present invention relates to connector connection terminals, and in particular, to a connection terminal incorporated in a connector for connecting a flexible print substrate.

2. Related Art

Conventionally, the connector connection terminal may be an electrical connector including a contact with a fixed beam and a movable beam extending along an inserting direction of a connection target, an insulating housing for interiorly holding the contact, and an actuator, positioned on the side opposite to the side of inserting the connection target, for elastically deforming the contact so as to come in contact with the connection target, the movable beam of the contact being supported in a freely oscillating manner by way of a coupling spring for joining the movable beam and the fixed beam, where the coupling spring has a shape extending in a curved manner towards a connector back end side or the direction the connection target is inserted from the joint portion of the fixed beam, as described in Japanese Unexamined Patent Publication No. 2007-227302.

As shown in FIG. 2 of Japanese Unexamined Patent Publication No. 2007-227302, in the electrical connector, a contact projection 13a of a movable beam 13 and a contact projection 14a of a fixed beam 14 are faced to each other in an approaching and separating manner, and a free end of the fixed beam 14 is slightly curved upward to enhance the contact reliability. Thus, the holding strength of the conductive terminal in the insulating housing is small, where if the curve of the fixed beam 14 is made small to increase the holding strength, the displacement amount of the contact projection 14a becomes small and the contact reliability is lowered.

Furthermore, the electrical connector is demanded lower height and miniaturization, and the connector connection terminal incorporated in the electrical connector is also demanded lower height and miniaturization.

For instance, in an electrical connector, the height dimension of the insulating housing is smaller than or equal to 1 mm, a conductive thin plate having a plate thickness of smaller than or equal to 0.2 mm is used for the connector connection terminal incorporated in the electrical connector, and great number of connector connection terminals are arranged in the housing at a pitch of between 0.3 and 0.5 mm.

### SUMMARY

However, there is a limit to lowering the height of the connector connection terminal and miniaturizing the same since the connector connection terminal is normally manufactured by punching out the conductive thin plate through press working. In particular, it is not easy to mold the fixed beam having a free end that curves to be smaller by press working, and even if molded, the holding strength and the contact reliability of the connector connection terminal with respect to the base are low. 2

One or more embodiments of the present invention provides a connector connection terminal having a lower height and being miniaturized while ensuring the desired holding strength and contact reliability.

In accordance with one aspect of the present invention, a connector connection terminal includes a fixed piece to be inserted and fixed to a base of a connector, a coupling portion projecting out from an upper side of the fixed piece, and a movable piece extending along the fixed piece from an upper end of the coupling portion and having one end as an upper contact and another end acting as an operation receiving portion, a lower contact being arranged at a position facing the upper contact of the upper side of the fixed piece, and the operation receiving portion of the movable piece being operated with an operation lever rotatably supported by the base; wherein an elastic arm is cut out with a slit formed along the upper side of the fixed piece to define a free end of the elastic arm as a lower contact; and an aspect ratio of a cross-sectional area of the elastic arm is greater than or equal to 1.2.

According to one or more embodiments of the present invention, a slit is formed and cut out on the upper side of the fixed piece and the aspect ratio of the cross-sectional area of the elastic arm having a lower contact at the free end is greater than or equal to 1.2. Thus, the elastic arm is easily elastically deformed, and the holding strength is not lowered even if the fixed piece is inserted and fixed to the base. As a result, a connector connection terminal having a lowered height and being miniaturized while ensuring the desired contact reliability and holding strength is obtained.

In another aspect of the present invention, a connector connection terminal includes a fixed piece to be inserted and fixed to a base of a connector, a coupling portion projecting out from an upper side of the fixed piece, and a movable piece extending along the fixed piece from an upper end of the coupling portion and having one end as an upper contact and another end acting as an operation receiving portion, a lower contact being arranged at a position facing the upper contact of the upper side of the fixed piece, and the operation receiving portion of the movable piece being operated with an operation lever rotatably supported by the base; wherein an elastic arm is cut out with a slit formed along the upper side of the fixed piece to define a free end of the elastic arm as a lower contact; and an aspect ratio of a cross-sectional area of the slit is greater than or equal to 1.2.

According to one or more embodiments of the present invention, a slit having an optimum cross-sectional area is formed to cut out the elastic arm, and thus a connector connection terminal having a lowered height and being miniaturized while ensuring the desired contact reliability and holding strength is obtained.

In still another aspect of the present invention, a connector connection terminal includes a fixed piece to be inserted and fixed to a base of a connector, a coupling portion projecting out from an upper side of the fixed piece, and a movable piece extending along the fixed piece from an upper end of the coupling portion and having one end as an upper contact and another end acting as an operation receiving portion, a lower contact being arranged at a position facing the upper contact of the upper side of the fixed piece, and the operation receiving portion of the movable piece being operated with an operation lever rotatably supported by the base; wherein an elastic arm is cut out with a slit formed along the upper side of the fixed piece to define a free end of the elastic arm as a lower contact; and an aspect ratio of a cross-sectional area of a bottom positioned on a lower side of the slit is greater than or equal to 1.2.

According to one or more embodiments of the present invention, the bottom positioned on the lower side of the slit that cut out the elastic arm has an optimum cross-sectional area, and thus a connector connection terminal having a lowered height and being miniaturized while ensuring the desired contact reliability and holding strength is obtained.

A connector according to one or more embodiments of the present invention has a configuration incorporating the connector connection terminal in the base.

According to one or more embodiments of the present invention, a connector capable of having a lowered height and being miniaturized while ensuring the desired holding strength and contact reliability is obtained.

Other aspects and advantages of the invention will be apparent from the following description and the appended claims.

### BRIEF DESCRIPTION OF DRAWINGS

FIG. 1 is a perspective view of a connector incorporating a connector connection terminal according to one or more embodiments of the present invention;

FIG. 2 is an exploded perspective view of the connector shown in FIG. 1;

FIGS. 3A to 3E are a perspective view, a perspective view of a different angle, a plan view, a front view, and a bottom view of the first connection terminal shown in FIG. 2;

FIG. 4 is a perspective view describing a manufacturing method of the first connection terminal shown in FIG. 2; and

FIG. 5A is a plan view of the connector shown in FIG. 1, and FIG. 5B is a cross-sectional view taken along the line B-B of FIG. 5A.

### DETAILED DESCRIPTION

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

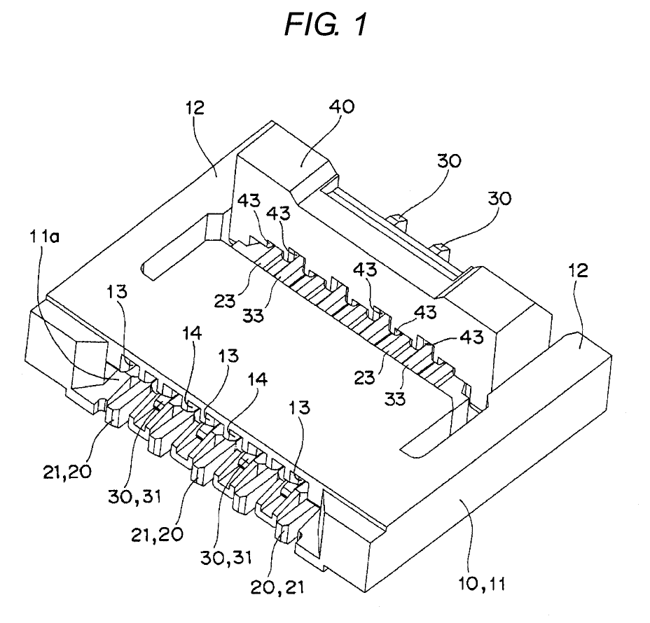

Hereinafter, an embodiment in which a connector connection terminal according to one or more embodiments of the present invention is incorporated in a connector will be described with reference to FIG. 1 to FIG. 5.

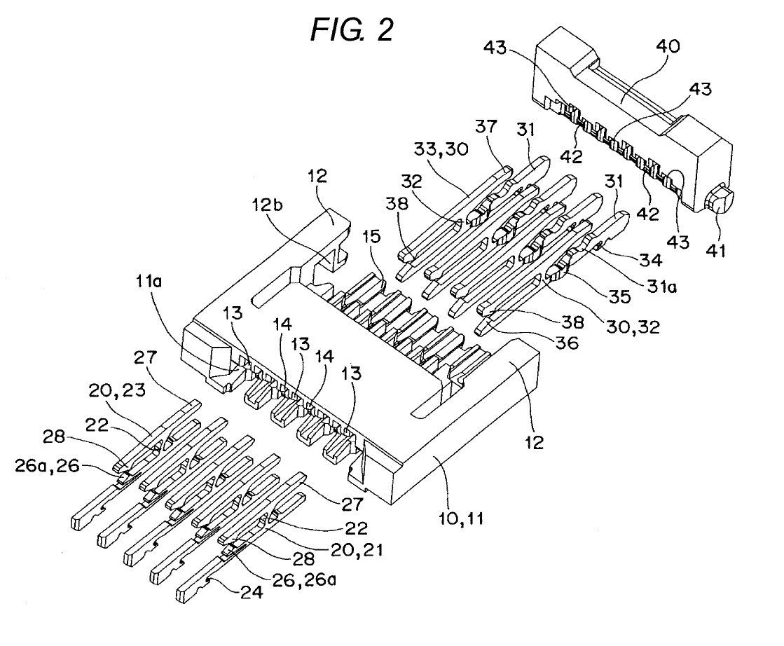

As shown in FIG. 1, the present embodiment is a case applied to a connector 10 for connecting a flexible print substrate (not shown). As shown in FIG. 2, the connector 10 broadly includes a base 11, a first connection terminal 20, a second connection terminal 30, and an operation lever 40.

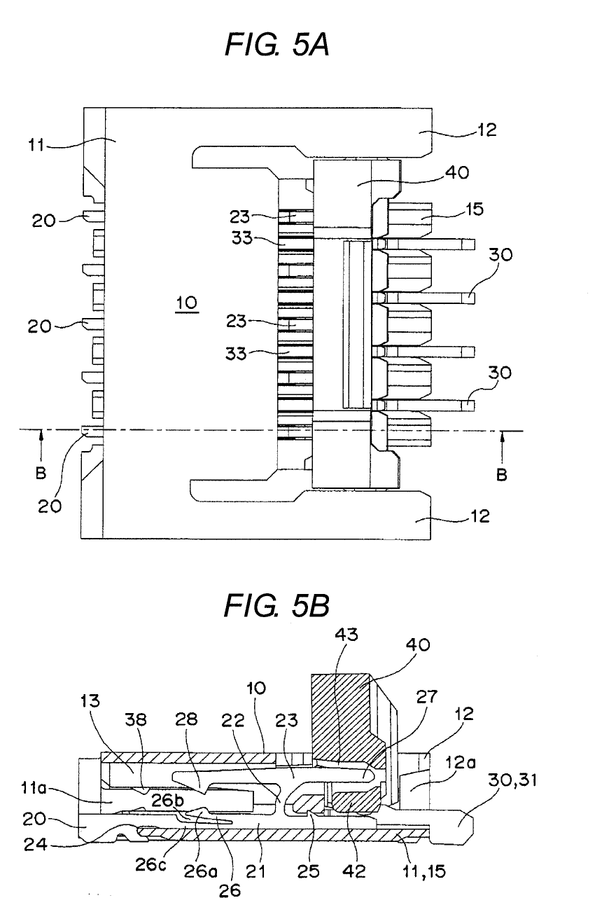

The base 11 has elastic arms 12, 12 extending in parallel to the rear surface side from an edge on one side of both side end surfaces. In an inward surface of the elastic arm 12, a guide tapered surface 12a (FIG. 5B) is formed at a distal end edge and a bearing slit 12b (FIG. 2) is formed on the far side. The base 11 includes, on a front surface side, an opening 11a to which a distal end of the flexible print substrate (not shown) can be inserted, where a first insertion hole 13 passing from the front surface to the rear surface is arranged side by side at a predetermined pitch. The base 11 has a guide plate 15 extending between the elastic arms 12, 12 from the edge on the lower side of the rear surface, and second insertion holes 14 arranged side by side at positions adjacent to the first insertion holes 13.

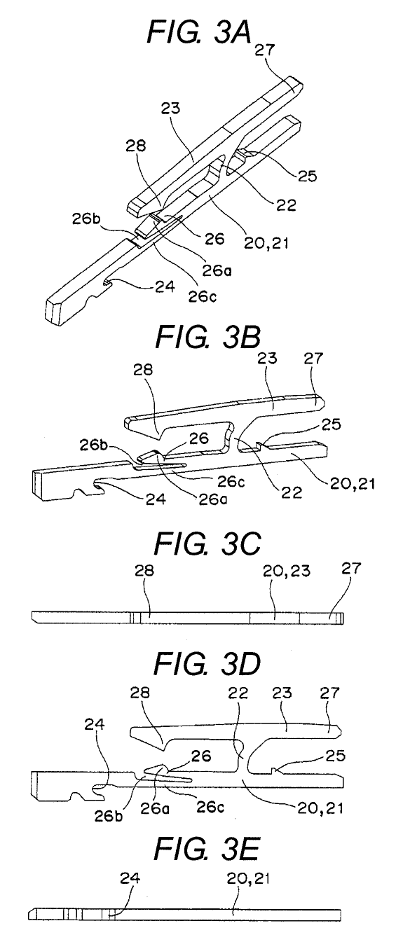

As shown in FIG. 3, the first connection terminal 20 includes a fixed piece 21 to be inserted and fixed to the first insertion hole 13 of the base 11, a coupling portion 22 arranged in a projecting manner at the upper side of the fixed piece 21, and a movable piece 23 extending substantially parallel to the fixed piece 21 to both sides from the upper end of the coupling portion 22, and has a thickness of 0.1 mm, for example.

The fixed piece 21 has a locking nail 24 for locking and positioning to the edge of the base 11 at one end on the lower side, and a cutout 25 and an elastic arm 26 on the upper side with the coupling portion 22 in between. The free end of the elastic arm 26 is a lower contact 26a.

Through the formation of the first connection terminal 20 according to the present embodiment through electroforming, to be hereinafter described, the pointed end portion 27 of the desired angle can be manufactured with one electroforming step, so that a plurality of press operation steps are not necessary as in the press working.

The aspect ratio of the cross-sectional area of the elastic arm 26 is between 1.2 and 4, and preferably between 1.5 and 3. If smaller than 1.2, definite effects cannot be obtained in the lowering of the height and the miniaturization, and if greater than 4, the desired strength is not obtained.

Furthermore, the aspect ratio of the cross-sectional area of the slit 26b for cutting out the elastic arm 26 from the fixed piece 20 is between 1.2 and 4, and preferably between 1.5 and 3. If smaller than 1.2, definite effects cannot be obtained in the lowering of the height and the miniaturization, and if greater than 4, the desired displacement amount is difficult to obtain.

The aspect ratio of the cross-sectional area of the bottom 26c positioned on the lower side of the slit 26b is between 1.2 and 4, and preferably between 1.5 and 3. If smaller than 1.2, definite effects cannot be obtained in lowering of the height and the miniaturization, and if greater than 4, the desired strength is not obtained.

The coupling portion 22 couples the fixed piece 21 with the movable piece 23 and rotatably supports the movable piece 23, where the aspect ratio at the cross-sectional area thereof is between 1.2 and 4, and preferably between 1.5 and 3. If smaller than 1.2, a definite change is not found in the improvement of the operation force and the contact force, and if greater than 4, the desired durability is not obtained.

The movable piece 23 has one end as an operation receiving portion 27 and an upper contact 28 is arranged at the other end. The upper contact 28 is positioned immediately above the lower contact 26a.

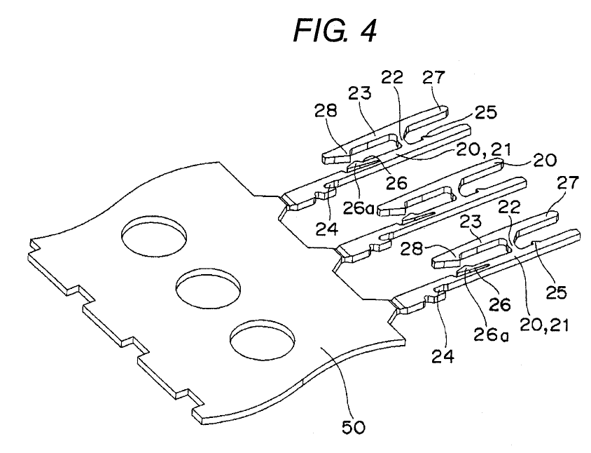

The manufacturing method of the first connection terminal 20 having the aspect ratio mentioned above includes an electroforming method of simultaneously forming with a hoop material 50, as shown in FIG. 4. The electroforming method electrodeposits the metal to the portion not covered with an insulating film of the bottom surface of a cavity of a master block by applying voltage between the mother block (not shown) and the opposing electrode. When current is flowed, the metal also electrodeposits on the insulating film covering one part of the bottom surface. In this case, the metal layer covering the insulating film grows with a delay from the metal layer electrodeposited on the portion not covered with the insulating film. That is, the irregular surface and the tapered surface of the first connection terminal 20 are formed by the irregularities of the cavity surface of the master block and the presence of the insulating film.

The material of the first connection terminal 20 is required not only to enable the desired shape and physicality to be obtained, but also that the electroforming solution is less likely to be subjected to alteration. Thus, the material of the first connection terminal 20 may be nickel-silver alloy, nickel-tungsten alloy, nickel-cobalt alloy, nickel-palladium alloy, and the like in addition to copper elemental substance and nickel elemental substance.

As shown in FIG. 2, the second connection terminal 30 includes a fixed piece 31 to be inserted to and fixed to the second insertion hole 14 of the base 11, a coupling portion 32 arranged in a projecting manner at the upper side of the fixed piece 31, and a movable piece 33 extending substantially parallel to the fixed piece 31 to both sides from the upper end of the coupling portion 32.

The manufacturing method, the material, and the thickness of the second connection terminal 30 are similar to the first connection terminal 20, and thus the description thereof will not be given.

The fixed piece 31 has a locking nail 34 for locking and positioning to the edge of the base 11 at one end on the lower side, and a slip-out prevention projection 35 at the base of the coupling portion 32. The slip-out projection 35 is formed to bulge out in the plate thickness direction. The fixed piece 31 also has a bearing portion 31a formed on the upper side positioned between the locking nail 34 and the slip-out prevention projection 35. The fixed piece 31 has the end on the upper side positioned on the opposite side of the locking nail 34 as the lower contact 36.

The coupling portion 32 couples the fixed piece 31 with the movable piece 33 and rotatably supports the movable piece 33, where the aspect ratio at the cross-sectional area thereof is between 1.2 and 4, and preferably between 1.5 and 3. If smaller than 1.2, a definite change is not found in the improvement of the operation force and the contact force, and if greater than 4, the desired durability is not obtained.

The movable piece 33 has one end as an operation receiving portion 37 and the other end arranged with an upper contact 38. The upper contact 38 is arranged immediately above the lower contact 36.

As shown in FIG. 2, the operation lever 40 has turning shaft parts 41, 41 arranged in a projecting manner on the same axis center on both side end surfaces. The operation lever 40 has a cam portion 42 for operating the operation receiving portions 27, 37 of the first and second connection terminals 20, 30 arranged at a predetermined pitch on the edge on one side, and a through-hole 43 to which the operation receiving portions 27, 37 are inserted is arranged at a position corresponding to the cam portion 42.

The flexible print substrate (not shown) connected to the connector 10 according to the present embodiment may have first and second connection pads, which are print wired on the upper surface of one end thereof, alternately arranged in a zigzag manner.

The assembly method of the configuring parts described above will now be described.

First, one end of the first connection terminal 20 is inserted to the first insertion hole 13 from the opening 11a on the front surface side of the base 11. As shown in FIG. 5, the slip-out preventing projection 25 of the first connection terminal 20 thus locks to the roof surface of the slip-out preventing portion of the base 11, and the locking nail 24 locks to and is positioned at the edge of the base 11 (FIGS. 7A to 7C).

The one end of the second connection terminal 30 is inserted to the second insertion hole 14 along the guide plate 15 of the base 11. Thus, the slip-out preventing projection 35 of the second connection terminal 30 locks while pushing and spreading in the up and down direction. At the same time, the locking nail 34 locks to and is positioned at the edge of the base 11.

The operation receiving portions 27, 37 of the first and second connection terminals 20, 30 are inserted to the through-holes 43 of the operation lever 40. Then, the operation lever 40 is slipped along the upper surface of the fixed piece 31 of the second connection terminal 30, and the operation receiving portions 27, 37 are pushed up and pushed in while being elastically deformed with the cam portion 42. Therefore, the cam portion 42 is fitted to a bearing portion 31a of the second connection terminal 30, and the turning shaft part 41 first to the bearing slit 12b of the base 11, whereby the operation lever 40 is rotatably supported.

The method of connecting and fixing the flexible print substrate (not shown) to the connector 10 will be described based on FIGS. 2A, 2B and FIGS. 8A to 8C.

As shown in FIG. 1, one end of the flexible print substrate (not shown) is inserted to the opening 11a of the base 11 until hitting the inner side surface of the base 11. When the operation lever 40 is turned and pushed down with the axis center of the turning shaft part 41 as the center, the cam portion 42 simultaneously pushes up the operation receiving portions 27, 37 of the first and second connection terminals 20, 30 to cause the bending moment. Thus, the movable pieces 23, 33 turn with the coupling portions 22, 32 as the supporting point, and the lower contact 26a, 36 and the upper contact 28, 38 sandwich and conduct the first and second pads arranged in a zigzag manner at one end of the flexible print substrate.

In the present embodiment, the lower contacts 26a, 36 and the upper contacts 28, 38 respectively bite into the front and back surfaces of the flexible print substrate and prevent slipping out, and the elastic arm 26 of the first connection terminal 20 is elastically deformed, whereby the connector 10 with high contact reliability can be obtained.

When detaching the flexible print substrate from the connector 10, the cam portion 42 is inverted by turning the operation lever 40 in the opposite direction, and the bending moment on the operation receiving portions 27, 37 of the first and second connection terminals 20, 30 is released, and thereafter the flexible print substrate is pulled out.

The coupling portions 22, 32 of the first and second connection terminals 20, 30 may not necessarily be curved and may be straight.

The connector connection terminal according to the present invention is not limited to the above described embodiments, and may be incorporated into the other connector as a matter of course.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A connector connection terminal comprising:
a fixed piece to be inserted and fixed to a base of a connector,
a coupling portion projecting out from an upper side of the fixed piece, and
a movable piece extending along the fixed piece from an upper end of the coupling portion and having one end as an upper contact and another end acting as an operation receiving portion,
wherein a lower contact is arranged at a position facing the upper contact of the upper side of the fixed piece,
wherein the operation receiving portion of the movable piece is operated with an operation lever rotatably supported by the base,
wherein an elastic arm is cut out with a slit formed along the upper side of the fixed piece to define a free end of the elastic arm as a lower contact, and
wherein an aspect ratio of a cross-sectional area of the elastic arm is greater than or equal to 1.2.

2. The connector connection terminal according to claim 1, further comprising:
a fixed piece to be inserted and fixed to a base of a connector,
a coupling portion projecting out from an upper side of the fixed piece, and
a movable piece extending along the fixed piece from an upper end of the coupling portion and having one end as an upper contact and another end acting as an operation receiving portion,
wherein a lower contact is arranged at a position facing the upper contact of the upper side of the fixed piece,
wherein the operation receiving portion of the movable piece is operated with an operation lever rotatably supported by the base,
wherein an elastic arm is cut out with a slit formed along the upper side of the fixed piece to define a free end of the elastic arm as a lower contact, and
wherein an aspect ratio of a cross-sectional area of the slit is greater than or equal to 1.2.

3. The connector connection terminal according to claim 1, further comprising:
a fixed piece to be inserted and fixed to a base of a connector,
a coupling portion projecting out from an upper side of the fixed piece, and
a movable piece extending along the fixed piece from an upper end of the coupling portion and having one end as an upper contact and another end acting as an operation receiving portion,
wherein a lower contact is arranged at a position facing the upper contact of the upper side of the fixed piece,
wherein the operation receiving portion of the movable piece is operated with an operation lever rotatably supported by the base,
wherein an elastic arm is cut out with a slit formed along the upper side of the fixed piece to define a free end of the elastic arm as a lower contact, and
wherein an aspect ratio of a cross-sectional area of a bottom positioned on a lower side of the slit is greater than or equal to 1.2.

4. A connector comprising the connector connection terminal according to claim 1.
